(19) United States
(12) Patent Application Publication
(10) Pub. No.: US 2016/0129814 A1
(43) Pub. Date: May 12, 2016

(54) PIVOTABLE BACKREST ASSEMBLY FOR A VEHICLE INTERIOR

(71) Applicant: BOS GMBH & CO. KG, Ostfildern (DE)

(72) Inventors: Andreas GOEBBELS, Kuerten (DE); Bogdan TUTELEA, Leichlingen (DE); Wolfgang SITZLER, Wuppertal (DE); Juergen SALEWSKI, Duesseldorf (DE); Hartmut BOHLKE, Wuppertal (DE); Wolfram ZUMMACK, Troisdorf (DE)

(21) Appl. No.: 14/771,087

(22) PCT Filed: Feb. 27, 2014
(86) PCT No.: PCT/EP2014/053843

§ 371 Date: Aug. 27, 2015

(30) Foreign Application Priority Data
Mar. 8, 2013 (DE) 102013204000.8

(51) Int. Cl. B60N 2/46; B60N 3/10

(52) U.S. Cl. CPC B60N 2/4686; B60N 2/4606; B60N 3/102

(57) ABSTRACT

A pivotable backrest arrangement for a vehicle interior in which a container receptacle for at least one beverage container is integrated, the container receptacle being open toward a functional surface of the backrest arrangement and including a cover frame, which is at least substantially flush with the functional surface, and a side wall region and a base region. The base region is held in an elastically yielding manner in relation to a backrest surface of the backrest arrangement, to which the base region is adjacent.

The invention relates to a pivotable backrest arrangement for a vehicle interior, in which a container receptacle for at least one beverage container is integrated, said container receptacle being open toward a functional surface of the backrest arrangement and comprising a cover frame, which is at least substantially flush with the functional surface, and a side wall region and a base region.

It is generally known from passenger vehicles with a rear seat bench that the central armrest is mounted movably between an inoperative position integrated in a backrest of the rear seat bench and a forwardly pivoted functional position. In the forwardly pivoted functional position, the central armrest has an upwardly pointing functional surface in which a container receptacle for at least one beverage container is integrated. In the swung-upward inoperative position of the central armrest, the central armrest, together with the lower side thereof opposite the functional surface, forms part of the backrest surface of the backrest of the rear seat bench.

It is the object of the invention to provide a pivotable backrest arrangement of the type mentioned at the beginning which, in the pivoted-upward inoperative position, has a comfortable support function.

This object is achieved in that the base region is held in an elastically yielding manner in relation to a backrest surface of the backrest arrangement, to which the base region is adjacent, the base region being of dimensionally stable design. Good support of the backrest arrangement is achieved by adequate padding between a backrest surface of the backrest arrangement and the base region of the container receptacle. If the padding between the backrest surface and the base region of the container receptacle is relatively thin because of a relatively narrow design of the backrest arrangement, the elastic yield according to the invention of the base region in the upwardly pivoted inoperative position of the backrest arrangement nevertheless ensures a comfortable support function. The dimensionally stable design of the base region permits a secure position and good base support of at least one beverage container deposited in the container receptacle as soon as the backrest arrangement is pivoted downward into the functional position thereof. By means of the solution according to the invention, imprints of the container receptacle in the remaining and quite small residual padding thickness, which is produced in particular from a foam material, of the pivotable backrest arrangement are greatly reduced or entirely avoided. By means of the dimensionally stable base region, the padding is supported uniformly on the base region of the container receptacle. In addition, it is also avoided that the base region buckles when beverage containers are inserted or adjusted. In the upwardly pivoted inoperative position of the backrest arrangement, the container receptacle is uniformly inwardly deflected as soon as a person leans against the backrest arrangement. Owing to the fact that the base region is of dimensionally stable design, the side wall region can be designed to be particularly soft and compliant, and therefore the support comfort is increased in relation to known backrest arrangements despite the small padding thickness. The solution according to the invention is particularly advantageously useable in central armrests in the rear region of a motor vehicle. Since the space required in a motor vehicle and the corresponding utilization of space are of ever greater importance, a central armrest of particularly shallow construction can be obtained by the solution according to the invention without a reduction in support comfort or container receptacle comfort.

In a refinement of the invention, the side wall region is produced from an elastically pliant, flexible material, in particular an elastomer material. The side wall region is preferably designed to be closed in an encircling manner. The elastomer material is understood as meaning both a pure elastomer, such as, in particular, natural or synthetic rubber, and also a thermoplastic elastomer.

According to one variant, the base region is produced from an elastically pliant, flexible material and merges in one piece into the side wall region. The base region is preferably produced from the same elastomer material as the side wall region. The side wall region and the base region are preferably produced together in a single-stage production process. The side wall region is connected releaseably or non-releaseably to the cover frame, which ends at least substantially flush with an outer skin of the backrest arrangement, in particular with a surface area of the functional surface of the backrest arrangement.

In a further refinement of the variant, the base region and the side wall region are formed by a flexible plastic film, in particular an elastomer skin, which is connected in an integrally bonded and sheetlike manner to a foam body, which bounds the container receptacle, of the backrest arrangement. The elastomer skin can be formed by a thermoplastic elastomer film. The plastic film is preferably placed into a mold for obtaining the foam body, as a result of which the plastic film is insert molded with the foam of the foam body. This inevitably results in an integrally bonded, sheetlike connection between plastic film and foam body. Alternatively, it is possible to adhesively bond the foam body, after the production thereof, in a sheetlike manner to the plastic film.

In a further refinement of the variant, a dimensionally stable supporting plate which extends at least over an entire area of the base region is embedded between the padding of the backrest arrangement and the base region. Said supporting plate is used if the base region is produced from the elastically pliant, flexible material or is formed by the flexible plastic film. In the pivoted-upward inoperative position of the backrest arrangement, the dimensionally stable supporting plate forms an extensive distribution of the backrest forces over the dimensionally stable supporting plate when a person leans against the backrest surface, as a result of which, despite the container receptacle which is present, a uniform supporting and backrest function of the backrest surface of the backrest arrangement is produced for the person leaning thereagainst.

In a further refinement of the invention, the side wall region comprises clamping or supporting means for the positional securing of at least one beverage container. The clamping or supporting means are preferably of spring-elastic design in order to be able to clamp or support beverage containers of different size.

In a further refinement of the invention, the clamping or supporting means are integrated integrally in the side wall region. The clamping or supporting means are preferably produced as formations together with the production of the side wall region from an elastomer material. By means of this refinement, the clamping or supporting means are integrated in the soft components of the container receptacle that are formed by the side wall region. This integration is a considerable cost advantage over known backrest arrangements.

In a further refinement of the invention, the clamping or supporting means constitute separately produced parts which are connected releaseably or non-releaseably to the side wall region. The clamping or supporting means can be mechanical spring elements which are connected to the side wall region. Alternatively, the clamping or supporting means can be of cam-like or dome-like design in the form of hollow or solid bodies made from an elastomer material, which are connected in an integrally bonded or form-fitting manner to the side wall region.

In a further refinement of the invention, the side wall region and the base region form a closed, waterproof receiving cup. It is thereby ensured that liquids cannot flow into the interior of the backrest arrangement. The closed and watertight design of the receiving cup permits simple cleaning.

In a further refinement of the invention, the base region and the side wall region are designed to be dimensionally stable and in one piece with respect to each other and are arranged in a vertically displaceable manner relative to the cover frame fixed to the backrest arrangement, and the base region and the side wall region are supported on the cover frame via at least one elastic spring means. The elastic spring means which can be provided is in particular a tubular ring made from an elastomer material or else a helical compression ring which is arranged between side wall region and cover frame and supports the side wall region in relation to the cover frame. By means of this refinement, the elastic yielding function for the base region is achieved despite the dimensionally stable design of the base region.

In a further refinement of the invention, the entire container receptacle is held movably relative to the backrest surface of the backrest arrangement, and the container receptacle is connected via at least one elastic spring means to at least one dimensionally stable structural part of the backrest arrangement. In this refinement, the elastically yielding arrangement of the base region is achieved in a simple manner by the entire container receptacle being mounted movably to a limited extent relative to the backrest arrangement, in particular being vertically displaceable. In order to achieve an elastically pliant, limited movability of the container receptacle relative to the backrest arrangement, the at least one elastic spring means is provided which connects the container receptacle to a dimensionally stable structural part of the backrest arrangement, such as, in particular, to a frame strut of the backrest arrangement. In this refinement, the cover frame, the side wall region and the base region are formed integrally with respect to one another and are designed to be dimensionally stable. The container receptacle can therefore be designed as an injection molded part which can be produced in a simple manner and is made from a thermoplastic. The elastic pliability is produced by the mounting of the container receptacle within the backrest arrangement in a manner so as to be relatively movable to a limited extent.

Further advantages and features of the invention emerge from the claims and from the description below of preferred exemplary embodiments of the invention that are illustrated with reference to the drawings.

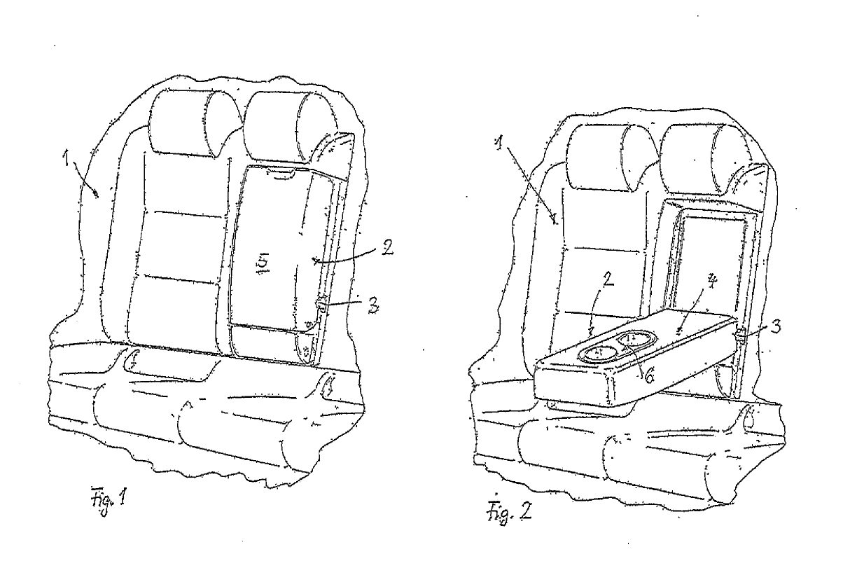

FIG. 1 shows, in a perspective illustration, an embodiment of a backrest arrangement according to the invention for a rear seat bench in a vehicle interior in an upwardly pivoted inoperative position,

FIG. 2 shows the backrest arrangement according to FIG. 1 in a downwardly pivoted functional position,

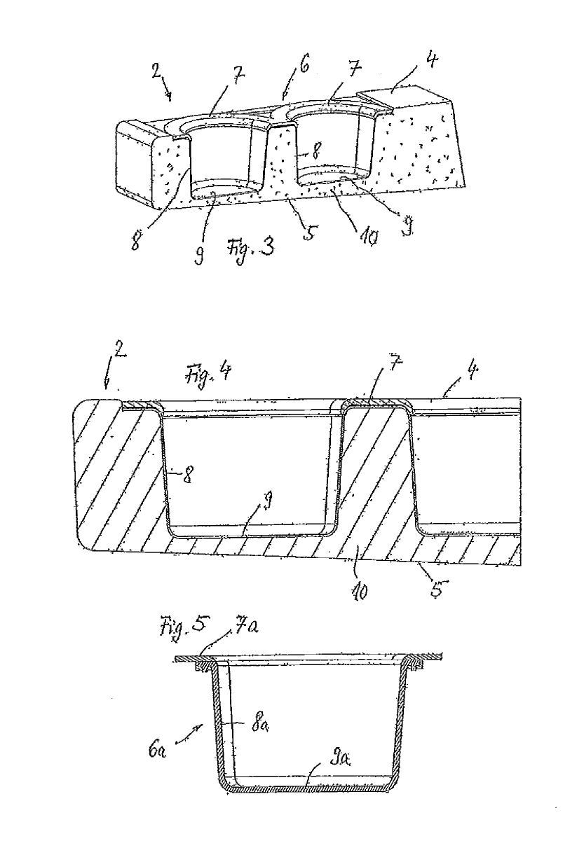

FIG. 3 shows schematically, in a cut-open isometric illustration, a first embodiment of a backrest arrangement according to the invention,

FIG. 4 shows, in an enlarged sectional illustration, the backrest arrangement according to FIG. 3,

FIG. 5 shows a container receptacle for a further embodiment of a backrest arrangement according to the invention similarly to FIGS. 3 and 4,

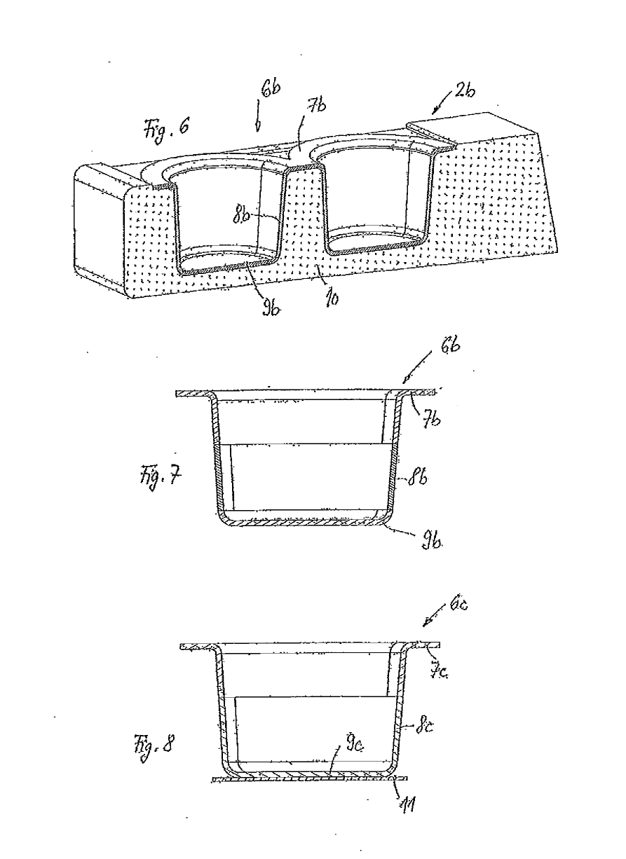

FIG. 6 shows schematically, in a partially cut-open, isometric illustration, a further embodiment of a backrest arrangement according to the invention,

FIG. 7 shows a container receptacle for the backrest arrangement according to FIG. 6 in a sectional illustration,

FIG. 8 shows a further container receptacle for a backrest arrangement similarly to FIG. 6, likewise in a sectional illustration,

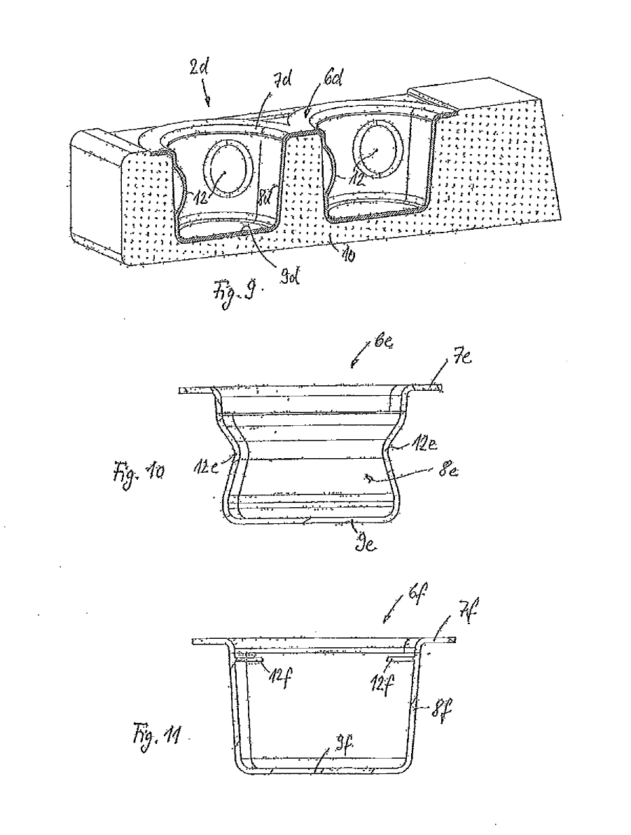

FIG. 9 shows schematically, in an isometric cut-open illustration, a further embodiment of a backrest arrangement according to the invention,

FIG. 10 shows, in a sectional illustration, a container receptacle for a backrest arrangement similarly to FIG. 9,

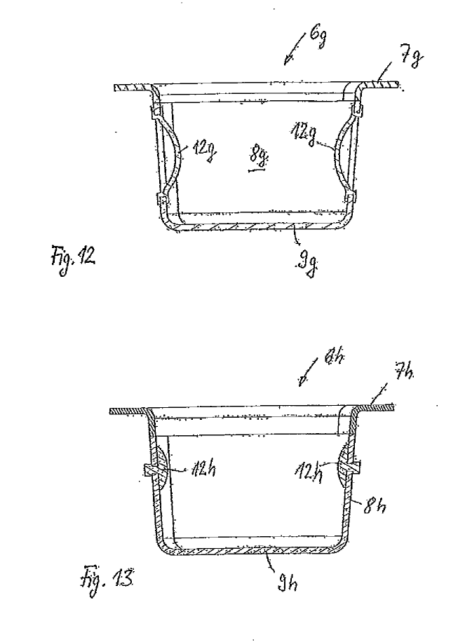

FIG. 11 shows, in a sectional illustration, a further container receptacle for a backrest arrangement similarly to FIG. 9,

FIG. 12 shows, in a sectional illustration, a further container receptacle for a backrest arrangement similarly to FIG. 9,

FIG. 13 shows, in a sectional illustration, a further container receptacle for a backrest arrangement similarly to FIG. 9,

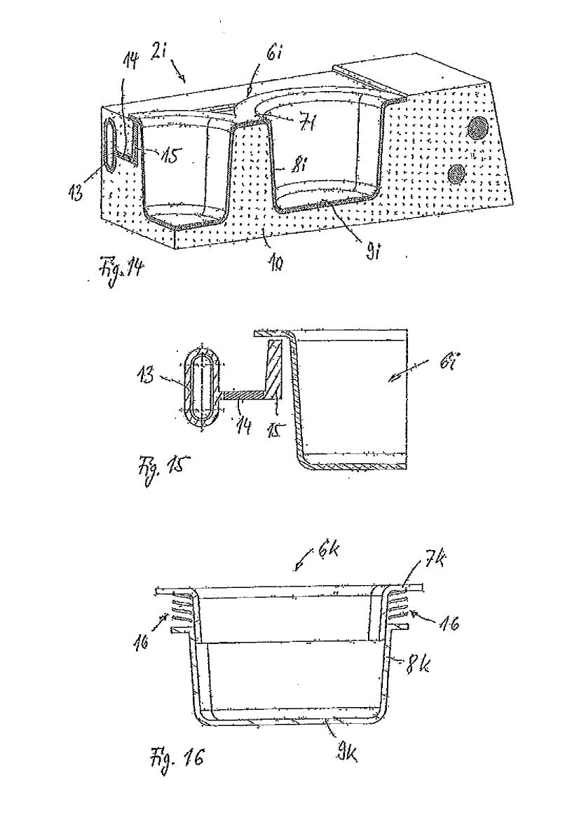

FIG. 14 shows, in a cut-open, schematic illustration, a further embodiment of a backrest arrangement according to the invention with a container receptacle which is dimensionally stable throughout,

FIG. 15 shows an enlarged sectional illustration of the backrest arrangement according to FIG. 14, and

FIG. 16 shows a sectional illustration of a container receptacle for a backrest arrangement similarly to FIG. 14.

A passenger vehicle has a seat arrangement on the driver's side and a seat arrangement on the passenger's side and a rear seat bench 1 behind said seat arrangements. The rear seat bench 1 in the vehicle interior is provided, in the region of a center of the vehicle, with a pivotable backrest arrangement 2 which, in a pivoted-upward inoperative position (FIG. 1), is integrated in a backrest arrangement of the rear seat bench 1 and carries out a backrest function for a person sitting in the rear seat bench 1. In the upwardly pivoted inoperative position, the backrest arrangement 2 has a backrest surface 5 which is directed forward in the direction of travel.

The backrest arrangement 2 can be pivoted forward and downward about a pivot mounting 3 from the pivoted-upward inoperative position into a functional position, in which a functional surface 4 which lies opposite the backrest surface 5 of the backrest arrangement 2, is directed upward and is oriented approximately horizontally. A container receptacle 6 is embedded from above in the said functional surface 4, the container receptacle ending approximately flush by an upper-side cover frame 7 (FIGS. 3 and 4) with the functional surface 4 of the backrest arrangement 2. In order to accommodate the container receptacle 6, the backrest arrangement 2 is recessed from the functional surface 4 in the direction of the backrest surface 5. Furthermore, the backrest arrangement 2 is provided with padding 10, which is designed as a foam body and fills corresponding cavities between backrest surface 5 and functional surface 4 in a sheetlike manner in order, in the upwardly pivoted inoperative position of the backrest arrangement 2, to obtain an upholstered support of the backrest surface 5. In addition, the backrest arrangement 2 comprises a dimensionally stable frame structure which is connected to the pivot mounting 3 and is not illustrated specifically in the drawings according to FIGS. 1 to 4. The dimensionally stable frame structure has at least one frame strut according to FIGS. 14 and 15 and serves for the configuration and stabilization of the backrest arrangement 2.

In the exemplary embodiment illustrated, the container receptacle 6 has two receiving cups which are open upward toward the functional surface 4 and are in each case formed by a side wall region 8 and a base region 9. An upper edge region of the container receptacle 6 is formed by the cover frame 7. The cover frame 7 is produced from a dimensionally stable plastic material, in particular a thermoplastic, such as ABS or the like.

In the embodiment according to FIGS. 3 and 4, the side wall regions 8 and the base regions 9 are formed by a flexible plastic skin which was inserted during the production of the foam body forming the padding 10. The flexible plastic skin is an elastomer skin which was inserted into the mold forming the foam body for the padding 10 and was insert molded by the plastic foam of the foam body. An integrally bonded connection is therefore produced between the foam body and the elastomer skin after the manufacturing. The elastomer skin forms a closed, but flexible thin wall in one continuous piece on the side wall regions 8 and on the base regions 9, which is raised to an upper side of the foam body in the region of the functional surface 4. The cover frame 7 covers the flexible film at the edge regions of the receiving cups. The padding 10 formed by the foam body is elastically pliable. Since the skin formed by the plastic film on the side wall regions 8 and the base regions 9 is flexible, the base region 9 and also a partial region of the side wall region 8 of each receiving cup can yield in an elastically pliable manner in the event of a pressure loading from the backrest surface 5. The dimensionally stable cover frame 7 is adhesively bonded onto the edge region of the receiving cups and therefore onto the plastic film.

In the embodiment according to FIG. 5, a backrest arrangement according to FIGS. 3 and 4 has a container receptacle 6a in which the base region 9a and the encircling side wall region 8a likewise merge into each other in one piece. An upper edge region of the side wall region 8a is connected in a form-fitting manner to the cover frame 7a which rests on the padding in the region of the upper side of the padding and is joined flush into the functional surface of the backrest arrangement. The side wall region 8a and the base region 9a are formed by a soft component in the form of a flexible, elastically pliable elastomer material which has the same wall thickness in the side wall region 8a and in the base region 9a. The container receptacle 6a can be accommodated in the corresponding recess in the padding of the backrest arrangement in a frictional manner or else in an integrally bonded manner by adhesive bonding, welding or the like.

In the embodiment according to FIGS. 6 and 7, the backrest arrangement 2b has a container receptacle 6b which is embedded in a corresponding recess in the padding 10. The container receptacle 6b is formed in the region of the two receiving cups by a respective base region 9b and a side wall region 8b, wherein the base region 9b is produced from a dimensionally stable plastic material, in particular ABS. The side wall region 8b is formed by a soft component in the form of an elastically pliable, flexible elastomer material which is connected to the base region 9b in an integrally bonded manner. The cover frame 7b, like the base region 9b, is formed by a dimensionally stable plastic material which is likewise connected in an integrally bonded manner to an upper edge region of the side wall region 8b. The cover frame 7b, the respective side wall region 8b and the associated base region 9b are preferably connected to one another in an injection molding process using the different plastic materials to form a single-piece shell body, as can be seen with reference to FIGS. 6 and 7. By means of the flexibility and the elastic pliability of the side wall regions 8b, an elastic yielding possibility of the base region 9b away from the backrest surface in the direction of the cover frame 7b is ensured.

In the embodiment according to FIG. 8, the container receptacle 6c, which is to be embedded in a backrest arrangement according to FIG. 6, is produced from a dimensionally stable plastic material only in the region of the cover frame 7c. The side wall region 8c and the base region 9c merge in one piece and in identical material into each other and are produced from an elastomer material. A dimensionally stable supporting plate 11 which can be injected into the foam body is fitted between the base region 9c and a foam body forming the padding. Said supporting plate permits a uniform support relative to the base region 9c and accordingly a uniform force introduction of compressive forces onto the backrest surface 5 in the direction of the base region 9c. Accordingly, in the event of pressure loadings on the backrest surface 5, the recess in the padded body in the region of the container receptacle 6c can virtually not be felt since, because of the supporting plate 11, the padding has an identically stable effect and an identically strong effect from the backrest surface 5 in the region of the recess for the container receptacle 6c as in the regions of the padded body laterally next to or between the recesses for the container receptacle 6c.

In the embodiments of backrest arrangements 2d according to FIGS. 9 to 13, the container receptacles 6d, 6e, 6f, 6g and 6h are additionally provided on the side wall regions 8d to 8h with clamping or supporting means 12, 12e to 12h, as is explained in more detail below. In the embodiment according to FIG. 9, the container receptacle 6d also has, in addition to the dimensionally stable cover frame 7d, dimensionally stable base regions 9d in the region of the two recesses within the padding 10. The dimensionally stable base regions 9d are upwardly adjoined by flexible and elastically pliable side wall regions 8d made from a thermoplastic elastomer material. The side wall regions 8d merge into the dimensionally stable cover frame 7d. Bubble- or dome-shaped bulges 12 which are directed toward the center of the container receptacle 6d, are not insert molded by the padding 10 and accordingly form cavities between padding 10 and the bulges 12 are provided in the flexible side wall regions 8d. The bulges 12 form clamping lugs which can yield outward in an elastically pliable manner as soon as a beverage container is inserted into the corresponding receiving cup. Accordingly, the clamping lugs 12 form a clamping and supporting function for the positional securing of the respective beverage container in the container receptacle 6d.

In the case of the container receptacle 6e according to FIG. 10, both the base region 9e and the side wall region 8e are formed from a flexible, elastically pliable elastomer material. The side wall region 8e is provided with a horizontally encircling constriction 12e which forms a corresponding clamping and supporting means for a beverage container. Also in this embodiment, between an edge of the padding (not illustrated) and the constriction 12e there is a horizontally annular cavity into which the constrictions 12e can yield outward because of the elasticity of the plastic material of the side wall region 8e. The curvature of the constriction is selected in such a manner that, after a beverage container is removed, the constriction 12e automatically springs back again into the inwardly curved starting position according to FIG. 10.

In the embodiment according to FIG. 11, the container receptacle 6f is likewise produced in the base region 9f and in the side wall region Of from a flexible, elastically pliable elastomer material. Approximately horizontally inwardly projecting, elastically pliable supporting webs 12f are integrally formed in one piece on the side wall region 8f directly below the cover frame 7f, which is of dimensionally stable design, the supporting webs forming corresponding clamping and supporting means for beverage containers to be inserted.

In the embodiment according to FIG. 12, the container receptacle 6g has, as clamping and supporting means, circular-arc-shaped supporting springs 12g which project inward from the side wall region 8g, are produced from plastic and have the same elastic pliability as the previously described clamping and supporting means 12 (FIG. 9). The supporting springs 12g can be designed in the manner of a leaf spring or can be of spherical design in some other way and are held in a form-fitting manner in corresponding cutouts in the side wall region 8g.

Also in the case of the container receptacle 6g, the base region 9g and the side wall region 8g are formed from a flexible, elastically pliable elastomer material so as to merge in one piece into each other.

In the case of the container receptacle 6h according to FIG. 13, the base region 9h and the side wall region 8h are likewise formed in one piece with respect to each other and are produced from a flexible, elastically pliable plastic material in the form of an elastomer or a thermoplastic elastomer. The side wall region 8h is upwardly connected to the dimensionally stable cover frame 7h. A plurality of knob-shaped clamping and supporting means in the form of elastomer domes 12h, which are connected in a form-fitting manner to the side wall region 8h, are inserted into the side wall region 8h. The elastomer domes 12h project toward the center of the container receptacle 6h and are of spherical design.

In the embodiment according to FIGS. 14 and 15, a backrest arrangement 2i is provided with a dimensionally stable frame structure which comprises at least one frame strut 13. The container receptacle 6i has two receiving cups which are each produced integrally from the base region 9i to over the side wall region 8i and as far as the cover frame 7i from a dimensionally stable plastic material. The cover frame 7i extends integrally over the two receiving cups. The dimensionally stable and integral container receptacle 6i formed in this manner is mounted in the recess within the padding 10 so as to be movable to a limited extent in the vertical direction. A lower side of the cover frame 7i is supported from below by supporting webs 15 which are connected via elastically pliable spring webs 14 to the frame strut 13 of the dimensionally stable frame structure of the backrest arrangement 2i. The supporting webs 15 can be connected to the cover frame 7i or merely bear against the latter from below. By means of the limited movability of the container receptacle 6i relative to the padding 10 and relative to the backrest arrangement 2i in the vertical direction, the respective base region 9i can yield toward the guide surface 4 (FIG. 2) in the event of a pressure loading from the backrest surface 5 (FIG. 1). If the supporting webs 15 are connected to the cover frame 7i, said supporting webs inevitably elastically pull the container receptacle 6i back again into the starting position within the recesses in the padding 10 via the spring force of the spring webs 14 once the loading has been removed. If the supporting webs 15 are not connected to the cover frame 7i, the container receptacle 6i can be pressed again into the starting position within the padding 10 via simple pressure from the functional surface 4, for example by inserting a beverage container.

In the embodiment according to FIG. 16, the container receptacle 6k is formed by a cover frame 7k and a side wall region 8k, which is movable telescopically relative to the cover frame 7k, but is separate from the cover frame 7k and merges in one piece into the base region 9k. The base region 9k and the side wall region 8k are produced as an integral receiving cup from a dimensionally stable plastic material. The cover frame 7k is designed in the manner of a funnel and is likewise produced in a dimensionally stable manner from a thermoplastic material. The cover frame 7k is fixed in the backrest arrangement (not illustrated). By contrast, the side wall region 8k and the base region 9k are mounted movably in the vertical direction within a corresponding recess in padding of the backrest arrangement. The upper edge region of the side wall region 8k has an outwardly projecting supporting flange on which mechanical spring elements 16 are supported. The spring elements 16 are upwardly supported in the region of a lower side of the cover frame 7k. In the exemplary embodiment illustrated, the spring elements 16 are designed as helical compression springs which, because of the stationary arrangement of the cover frame 7k within the backrest arrangement, permanently exert a compressive force downward on the supporting flange of the side wall region 8k. As soon as a compressive force is exerted on the base region 9k from below via the backrest surface of the backrest arrangement, the base region 9k can yield in the direction of the cover frame 7k. Once the pressure loading is removed, the spring elements 16 automatically press the base region 9k and the side wall region 8k back again into the starting position.

1. A pivotable backrest arrangement for a vehicle interior, in which a container receptacle for at least one beverage container is integrated, said container receptacle being open toward a functional surface of the backrest arrangement and comprising a cover frame, which is at least substantially flush with the functional surface, and a side wall region and a base region, wherein the base region is held in an elastically yielding manner in relation to a backrest surface of the backrest arrangement, to which the base region is adjacent, the base region being of dimensionally stable design.

2. The pivotable backrest arrangement as claimed in claim 1, wherein the side wall region is produced from an elastically pliant, flexible material, in particular an elastomer material.

3. The pivotable backrest arrangement as claimed in claim 2, wherein the side wall region comprises clamping or supporting means for positionally securing at least one beverage container.

4. The pivotable backrest arrangement as claimed in claim 3, wherein the clamping or supporting means are integrated integrally in the side wall region.

5. The pivotable backrest arrangement as claimed in claim 1, wherein the side wall region and the base region form a closed, waterproof receiving cup.

6. The pivotable backrest arrangement as claimed in claim 1, wherein the base region and the side wall region are designed to be dimensionally stable and in one piece with respect to each other and are arranged in a vertically displaceable manner relative to the cover frame fixed to the backrest arrangement, and wherein the base region and the side wall region are supported on the cover frame via at least one elastic spring means.
